(19) United States
(12) Patent Application Publication
(10) Pub. No.: US 2026/0071589 A1
(43) Pub. Date: Mar. 12, 2026

(54) PROPULSION ASSEMBLY COMPRISING A DAMPING REAR ENGINE ATTACHMENT, AIRCRAFT HAVING AT LEAST ONE SUCH PROPULSION ASSEMBLY

(71) Applicant: Airbus Operations SAS, TOULOUSE (FR)

(72) Inventors: Frédéric JOURNADE, TOULOUSE (FR); Olivier PAUTIS, TOULOUSE (FR); Jérôme COLMAGRO, TOULOUSE (FR); Germain GUENEAU, TOULOUSE (FR); Marc DE NICOLA, TOULOUSE (FR); Fabrice GRIMAL, TOULOUSE (FR)

(21) Appl. No.: 19/318,951

(22) Filed: Sep. 4, 2025

(30) Foreign Application Priority Data
Sep. 6, 2024 (FR) FR2409450

(51) Int. Cl. F02K 1/00; B64D 27/16; B64D 27/40

(52) U.S. Cl. CPC F02K 1/00; B64D 27/16; B64D 27/402

(57) ABSTRACT

A propulsion assembly with a damping rear engine attachment, aircraft having at least one such propulsion assembly. The propulsion assembly has an engine attachment system, connecting a primary structure of a pylon and a motor, which has a plurality of attachments each having at least one engine anchor point on the motor, all the engine anchor points being approximately positioned in the same transverse plane, a damping rear engine attachment connecting the primary structure and the rear part of the jet engine core, the damping rear engine attachment forming a force path that has at least one elastically deformable element.

### CROSS-REFERENCES TO RELATED APPLICATIONS

This application claims the benefit of French Patent Application Number FR2409450 filed on Sep. 6, 2024, the entire disclosure of which is incorporated herein by way of reference.

### FIELD OF THE INVENTION

The present application relates to a propulsion assembly comprising a damping rear engine attachment and to an aircraft having at least one such propulsion assembly.

### BACKGROUND OF THE INVENTION

According to a configuration of the prior art that is visible in FIG. 1 and FIG. 2, an aircraft 10 comprises a plurality of propulsion assemblies 12 that are positioned beneath the wing 14 of the aircraft 10.

A propulsion assembly 12 comprises a motor 16, a nacelle (not shown in FIG. 2) positioned around the motor 16, and a pylon 18 connecting the motor 16 to the rest of the aircraft 10, in particular to the wing 14.

A device is known, in particular according to patent application US 2009/0134271 A1, which has a turbojet engine suspended from a pylon, in which a pylon structure is rigidly attached to the intermediate casing by a front attachment and to the exhaust casing by a rear attachment. However, this solution, which proposes rigid attachments, does not satisfactorily address the problem of filtering the substantial forces and the vibrations coming from the rear part of the jet engine.

An electric propulsion assembly is also known, according to patent application EP 4 299 445 A1, in which the propulsion system and the energy source are mounted on distinct and dissociated supports in order to avoid the transmission of the vibrations. However, this solution is specific to distributed electric propulsion architectures and does not address the problem of managing the forces within a conventional turbojet engine in which the core of the jet engine and the fan form an integrated unit.

A propulsion unit is also known, according to patent application US 2022/0411084 A1, which provides distinct load paths for the forces perpendicular and parallel to the axis of rotation. However, this solution relies on rigid connections and does not satisfactorily address the problem of filtering and damping the forces specific to the rear part of a turbojet engine core.

For the remainder of the description, a longitudinal direction X is parallel to the axis of rotation of the motor A16. A transverse plane is a plane perpendicular to the axis of rotation of the motor A16. A vertical median plane is a vertical plane passing through the axis A16 of the motor. A transverse and horizontal direction Y is a direction that is perpendicular to the axis of rotation of the motor A16 and horizontal. A transverse and vertical direction Z is a direction that is perpendicular to the axis of rotation of the motor A16 and vertical. A vertical median plane is a vertical plane containing the axis of rotation of the motor A16. The terms front and rear refer to the direction of flow of the stream of air in the motor 16, this stream flowing from the front toward the rear.

The motor 16 comprises a fan 20 that has a fan casing 20.1 and a jet engine core 22 that has a front part 22.1 positioned inside the fan 20, a central part 22.2 and a rear part 22.3.

The pylon 18 comprises a primary structure 24, in the form of a box, which is connected to the wing 14 by a wing attachment system 26 (depicted in a simplified manner in FIG. 2 because it is outside the scope of the invention) and to the motor 16 by an engine attachment system 28. This primary structure 24 comprises a front end 24.1, a median part 24.2 and a rear end 24.3.

According to an embodiment visible in FIG. 2, the engine attachment system 28 comprises a first attachment 28.1 connecting the front end 24.1 of the primary structure 24 and the fan casing 20.1, a second attachment 28.2 connecting the front end 24.1 of the primary structure 24 and the front part 22.1 of the jet engine core 22 and a third attachment 28.3 having two rods, positioned symmetrically with respect to the vertical median plane of the motor 16, connecting the median part 24.2 of the primary structure 24 and the front part 22.1 of the jet engine core 22. According to this embodiment, the first, second and third attachments 28.1, 28.2, 28.3 are connected to the jet engine core 22 at points positioned approximately in one and the same transverse plane P1.

In certain cases, this solution does not allow optimum transfer of the forces between the motor 16 and the primary structure 24 of the pylon 18.

### SUMMARY OF THE INVENTION

The present invention aims to remedy all or some of the drawbacks of the prior art.

To this end, the invention presents a propulsion assembly comprising:
a) a motor that has a fan and a jet engine core having a front part, a central part and a rear part,
b) a primary structure of a pylon that has a front end, a median part and a rear end,
c) an engine attachment system, connecting the primary structure and the motor, which has a plurality of attachments each having at least one engine anchor point on the motor, all the engine anchor points being approximately positioned in one and the same transverse plane.

In accordance with the invention, the propulsion assembly comprises a damping rear engine attachment that has a first end connected to the primary structure and a second end connected to the rear part of the jet engine core, wherein said damping rear engine attachment forms a force path that has at least one elastically deformable element. In addition, the damping rear engine attachment comprises at least one body, at least one connecting axis connecting the body and one element from among the jet engine core and the primary structure, positioned in a longitudinal and vertical plane, and at least one elastomer ring interposed between the body and the connecting axis.

Thus, this engine attachment makes it possible to filter the substantial forces while at the same time reacting the less substantial forces, such as, for example, the weight of the rear part of the jet engine core. To this end, the invention also relates to an aircraft comprising a propulsion assembly as mentioned above.

The integration of such a propulsion assembly in the aircraft makes it possible to filter the substantial forces transmitted to the wing while at the same time reacting the less substantial forces.

### BRIEF DESCRIPTION OF THE DRAWINGS

Further features and advantages will become apparent from the following description of the invention, which description is given solely by way of example, with reference to the appended drawings in which:

FIG. 1 is a perspective view of an aircraft,
FIG. 2 is a side view of an aircraft propulsion assembly (without nacelle), illustrating an embodiment of the prior art,
FIG. 3 is a side view of an aircraft propulsion assembly (without nacelle), illustrating an embodiment of the invention,
FIG. 4 is a perspective view of an aircraft propulsion assembly (without nacelle), illustrating an embodiment of the invention,
FIG. 5 is a side view of a primary structure and of an engine attachment system, illustrating an embodiment of the invention,
FIG. 6 is a top view of a primary structure and of an engine attachment system, illustrating an embodiment of the invention,
FIG. 7 is a perspective view of a part of an engine attachment system, illustrating an embodiment of the invention,
FIG. 8 is a front view of a damping rear engine attachment, illustrating one embodiment of the invention, and,
FIG. 9 is a front view of a damping rear engine attachment, illustrating another embodiment of the invention.

### DETAILED DESCRIPTION OF THE PREFERRED EMBODIMENTS

According to an embodiment visible in FIG. 3 and FIG. 4, a propulsion assembly 30 comprises a motor 32, a nacelle (not shown) positioned around the motor 32 and a pylon 34 configured to connect the propulsion assembly 30, and more particularly the motor 32, to a wing 36 of an aircraft. The latter comprises at least one such propulsion assembly 30.

The motor 32 comprises a fan 38 and a jet engine core 40. The fan 38 has a fan casing 38.1. The jet engine core 40 has, from the front toward the rear, a front part 40.1 positioned inside the fan 38, a central part 40.2 and a rear part 40.3 incorporating in particular high-pressure and low-pressure turbines and ensuring, downstream, a join with a nozzle (not shown). According to one configuration, the central part 40.2 has a cross section smaller than those of the front and rear parts 40.1, 40.3.

The pylon 34 comprises a primary structure 42, in the form of a box, which is connected to the wing 36 by a wing attachment system 44 (depicted in a simplified manner in FIG. 3 because it is outside the scope of the invention) and to the motor 32 by an engine attachment system 46. This primary structure 42 comprises a front end 42.1, a median part 42.2 and a rear end 42.3.

According to an embodiment visible in FIG. 3 to FIG. 6, the engine attachment system 46 comprises a first attachment 48 connecting the front end 42.1 of the primary structure 42 and the fan casing 38.1, a second attachment 50 connecting the front end 42.1 of the primary structure 42 and the front part 40.1 of the jet engine core 40 and a third attachment 52 connecting the median part 42.2 of the primary structure 42 and the front part 40.1 of the jet engine core 40. According to this embodiment, the first, second and third attachments 48, 50, 52 are connected to the motor 32 at engine anchor points P48, P50, P52 positioned approximately (e.g., +/−10%) in one and the same transverse plane PT.

As illustrated in FIG. 4, according to one embodiment, the first attachment 48 is configured to react the forces in the longitudinal direction X and the transverse and horizontal direction Y. According to a configuration visible in FIG. 5 and FIG. 6, the first attachment 48 comprises a vertical first pivot axis A48, a cylindrical tenon 48.1 of spigot type, as one with the fan casing 38.1, which is vertical and has an axis coincident with the first pivot axis A48 and a plate 48.2 as one with the front end 42.1 of the primary structure 42, which is substantially (e.g., +/−10%) horizontal, which has an orifice 48.3 configured to house the cylindrical tenon 48.1 of spigot type with a tight fit.

The second attachment 50 is configured to react the forces in the horizontal and vertical transverse directions Y and Z. According to a configuration visible in FIG. 7, the second attachment 50 comprises at least one three-point shackle 54, a first connecting axis A56.1 connecting the three-point shackle 54 and the front end 42.1 of the primary structure 42 and second and third connecting axes A56.2, A56.3 connecting the three-point shackle 54 and the front part 40.1 of the jet engine core 40.

The first, second and third connecting axes A56.1, A56.2, A56.3 are parallel to each other and positioned in substantially vertical planes.

The three-point shackle 54 comprises two plates 54.1, 54.2 which are substantially parallel to each other and are slightly spaced apart from each other. Each plate 54.1, 54.2 is approximately triangular and has three through-orifices for housing the connecting axes A56.1 to A56.3, positioned at the vertices of each plate 54.1, 54.2. In addition, the second attachment 50 comprises a first tab 58 as one with the front end 42.1 of the primary structure 42, positioned between the two plates 54.1, 54.2 of the three-point shackle 54, which has an orifice for housing the first connecting axis A56.1 and at least one second tab 58′ as one with the front part 40.1 of the jet engine core 40, positioned between the two plates 54.1, 54.2 of the three-point shackle 54, which has two orifices for housing the second and third connecting axes A56.2, A56.3.

The first, second and third connecting axes A56.1 to A56.3 can be ball-jointed.

According to one arrangement, each of the first, second and third connecting axes A56.1 to A56.3 forms an angle of the order of 15 to 45°with a transverse plane. In parallel, each plate 54.1, 54.2 of the three-point shackle 54 is positioned in a plane perpendicular to the first, second and third connecting axes A56.1 to A56.3.

The third attachment 52 is configured to react the forces in at least one longitudinal direction X. It comprises two rods 60, positioned symmetrically with respect to the vertical median plane.

Each rod 60 has a first end 60.1 connected to the median part 42.2 of the primary structure 42 via a first connecting axis A60.1 and a second end 60.2 connected to the front part 40.1 of the jet engine core 40 via a second connecting axis A60.2. According to one arrangement, each second connecting axis A60.2 is positioned in a substantially horizontal plane. In addition, each first connecting axis A60.1 is positioned in a substantially longitudinal and vertical plane. Thus, the first and second connecting axes A60.1, A60.2 are oriented in two substantially perpendicular directions. Nevertheless, the angular orientation of the connecting axes A60.1 and A60.2 could be oriented in 2 substantially parallel or intermediate directions, without changing the scope of the invention. According to one embodiment, these connecting axes A60.1 and A60.2 could also be ball-jointed. Each of the first and second ends 60.1, 60.2 of each rod 60 comprises a clevis.

The third attachment 52 comprises, for each rod 60, a first tab 62 as one with the median part 42.2 of the primary structure 42 and connected via the first connecting axis A60.1 to the clevis of the first end 60.1 of the rod 60 and a second tab 64 as one with the front part 40.1 of the jet engine core 40 and connected via the second connecting axis A60.2 to the clevis of the second end 60.2 of the rod 60.

The first, second and third attachments 48, 50, 52 are not described further since they may be identical to those of the prior art.

Of course, the invention is not limited to this configuration for the engine attachment system. Whatever the embodiment, the engine attachment system 46 comprises a plurality of attachments 48, 50, 52 that each have at least one engine anchor point P48, P50, P52 on the motor 32, all the engine anchor points P48, P50, P52 being positioned approximately in one and the same transverse plane PT; at least one of the attachments 48, 50, 52 comprising a rear anchor point PA on the primary structure 42 that is situated furthest to the rear, at the median part 42.2 of the primary structure 42.

According to one feature of the invention, the propulsion assembly 30 comprises at least one damping rear engine attachment 66 that has at least one first end 66.1 connected to the primary structure 42 at an anchoring zone that is offset toward the rear with respect to the rear anchoring point PA of the engine attachment system 46, close to the rear end 42.3 of the primary structure 42, and at least one second end 66.2 connected to the rear part 40.3 of the jet engine core 40. The first and second ends 66.1, 66.2 are positioned in a substantially vertical plane.

As illustrated in FIG. 4, this damping rear engine attachment 66 is configured to react the forces in the horizontal and vertical transverse directions Y, Z. According to one configuration, the damping rear engine attachment 66 is configured to react the forces only in the horizontal and vertical transverse directions Y, Z. According to another configuration, the damping rear engine attachment 66 is configured to react the forces only in the horizontal transverse directions Y.

The damping rear engine attachment 66 comprises at least one body 68 connected to at least one element from among the jet engine core 40 and the primary structure 42 via at least one pivot axis positioned in a longitudinal and vertical plane.

According to a first embodiment, visible in FIG. 8, the damping rear engine attachment 66 comprises a body 68 connected to the jet engine core 40 by a first connection 70 comprising at least one first connecting axis A70 positioned in a longitudinal and vertical plane and to the primary structure 42 by a second connection 72 comprising at least one second connecting axis A72 positioned in a longitudinal and vertical plane. The first and second connecting axes A70, A72 are substantially parallel to each other.

According to one configuration, the body 68 is a three-point shackle that comprises at least one approximately triangular plate 74 having first, second and third through-orifices 74.1, 74.2, 74.3 positioned at the three vertices of the triangular shape. According to one design, the three-point shackle comprises two identical plates 74 that are substantially parallel to each other and are slightly spaced apart from each other. The damping rear engine attachment 66 comprises first, second and third connecting axes A70, A72, A72′ housed respectively in the first, second and third through-orifices 74.1, 74.2, 74.3 that each have a cylindrical body, at least one first tab 76, as one with the primary structure 42, which has an orifice for housing the first connecting axis A70 and at least one second tab 78, as one with the jet engine core 40, which has two orifices for housing the second and third connecting axes A72, A72′. Thus, the first connecting axis A70 connects the plate 74 and the first tab 76. The second and third connecting axes A72, A72′ connect the plate 74 and the second tab 78.

The first, second and third connecting axes A70, A72, A72′ are substantially parallel to each other and are each positioned in a longitudinal and vertical plane.

According to this first embodiment, the damping rear engine attachment 66 is configured to react the forces in the horizontal and vertical transverse directions Y, Z.

In order to obtain a damping effect, the damping rear engine attachment 66 comprises at least one elastomer ring 80 interposed between one connecting axis from among the first, second and third connecting axes A70, A72, A72′ and the body 68. According to one arrangement, the damping rear engine attachment 66 comprises at least one elastomer ring 80 interposed between each of the first, second and third connecting axes A70, A72, A72′ and the body 68.

Each ring 80 has a stiffness as a function of the desired damping effect. To give an order of magnitude, a ring 80 has a thickness (distance separating the inner wall in contact with a connecting axis and the outer wall in contact with the body 68) of between 10 and 40 mm.

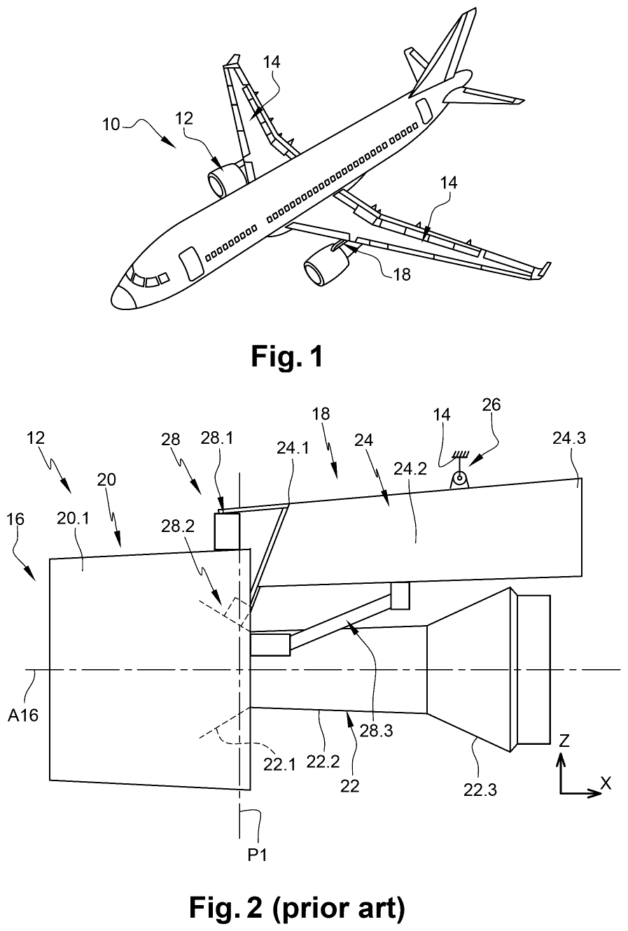

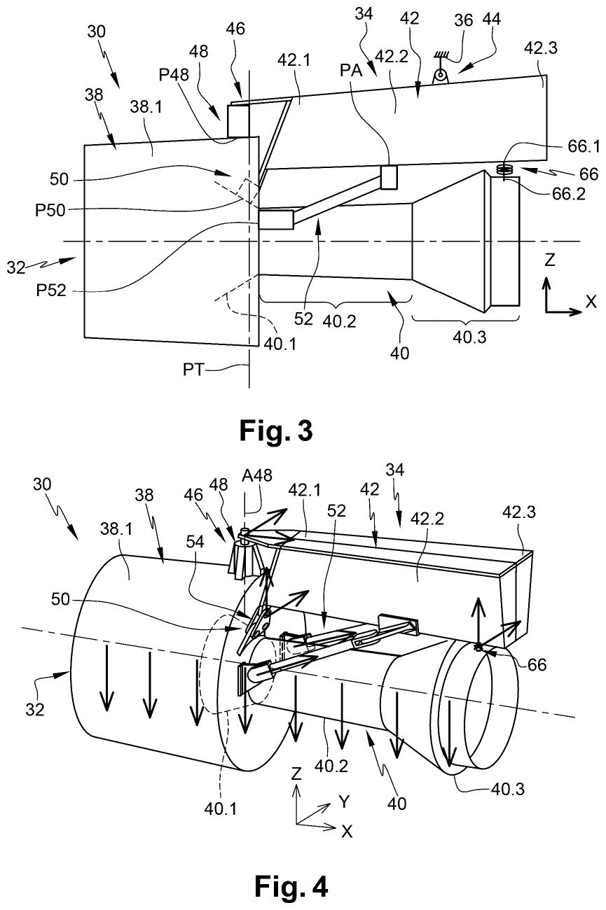

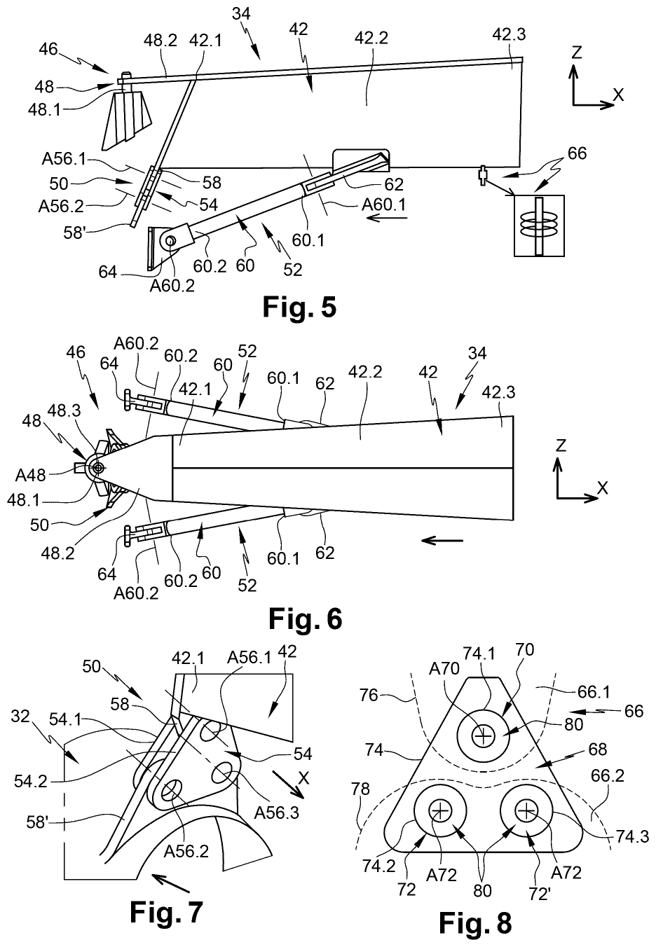

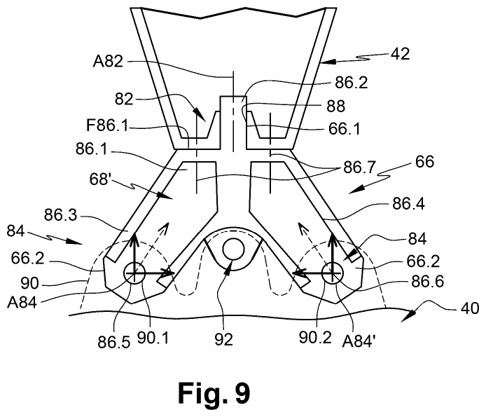

According to a second embodiment, visible in FIG. 9, the damping rear engine attachment 66 comprises a body 68′ connected to the primary structure 42 by a first connection 82 and to the jet engine core 40 by a second connection 84 comprising at least first and second connecting axes A84, A84′ that are each approximately positioned in a longitudinal and vertical plane. The first and second connecting axes A84, A84′ are substantially parallel to each other.

According to one configuration, the body 68′ comprises a base 86.1 that has a contact face F86.1 held pressed against the primary structure 42, a cylindrical tenon 86.2 of spigot type projecting with respect to the contact face F86.1 and first and second branches 86.3, 86.4 that form a V flared in the direction of the jet engine core 40 and respectively comprise first and second through-orifices 86.5, 86.6 for housing the first and second connecting axes A84, A84′. In addition, the damping rear engine attachment 66 comprises a housing 88, provided at the primary structure 42, configured to house with a tight fit the cylindrical tenon 86.2 of spigot type and at least one tab 90, as one with the jet engine core 40, which has first and second through-holes 90.1, 90.2 for respectively housing the first and second connecting axes A84, A84′. Thus, the latter connect the body 68′ and the jet engine core 40.

According to one embodiment, the first and second branches 86.3, 86.4 are configured to obtain a damping effect by virtue of a design that is optimized in terms of stiffness in the three directions X, Y and Z. In addition or as a variant, the damping rear engine attachment 66 comprises at least one elastomer ring interposed between one connecting axis from among the first and second connecting axes A84, A84′ and the body 68′. According to one arrangement, the damping rear engine attachment 66 comprises at least one elastomer ring 80 interposed between each of the first and second connecting axes A84, A84′ and the body 68′.

According to this configuration, the cylindrical tenon 86.2 of spigot type of the body 68′ and the housing 88 of the primary structure 42 essentially react the shear forces (positioned in an approximately horizontal plane) between the body 68′ and the primary structure 42. In addition, the damping rear engine attachment 66 comprises a holding system 86.7 (such as bolts inserted in sleeves, for example) configured to hold the base 86.1 of the body 68′ pressed against the primary structure 42 and essentially react the tensile forces oriented approximately vertically. This arrangement makes it possible to dissociate the reaction of the shear forces positioned in a horizontal plane and that of the tensile forces, which are oriented vertically.

As a variant, the first connection 82 comprises only vertical connection elements (such as bolts) that react the shear and tensile forces indifferently.

According to one arrangement, the damping rear engine attachment 66 comprises a backup safety connection 92 of “waiting fail-safe” type, connecting the body 68′and the jet engine core 40, configured not to generate a force path when the first and second connecting axes A84, A84′ are in an operative state and to generate an additional force path only in the event of failure of at least one of the first and second connecting axes A84, A84′.

According to this second embodiment, the damping rear engine attachment 66 is configured to react the forces in the longitudinal direction and horizontal and vertical transverse directions X, Y, Z and, by combination, the torsional moment Mx.

Whatever the embodiment, the propulsion assembly comprises a damping engine attachment 66 that has a first end 66.1 connected to the primary structure 42 at an anchoring zone that is offset toward the rear with respect to the rear anchoring point PA of the engine attachment system 46, and a second end 66.2 connected to the rear part 40.3 of the jet engine core. This damping rear engine attachment 66 forms a force path that has at least one elastically deformable element for absorbing by deformation some of the forces transiting between the rear part 40.3 of the jet engine core 40 and the primary structure 42. This elastically deformable element may be a ring, a sleeve or any other interposed element.

This damping rear engine attachment 66 generates a filtering force path that only drains the inertial forces coming only from the rear part 40.3 of the jet engine core 40 in which high-pressure and low-pressure turbines are in particular positioned. Thus, the damping rear engine attachment 66 makes it possible to filter the substantial forces while at the same time reacting the less substantial forces such as the weight of the rear part 40.3 of the jet engine core 40.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. A propulsion assembly comprising:
a motor with a fan and a jet engine core having a front part a central part and a rear part;
a primary structure of a pylon having a front end, a median part, and a rear end;
an engine attachment system connecting the primary structure and the motor, the engine attachment system having a plurality of attachments each having at least one engine anchor point on the motor, all of the engine anchor points being approximately positioned in a same transverse plane; and,
a damping rear engine attachment having a first end connected to the primary structure and a second end connected to the rear part of the jet engine core,
wherein said damping rear engine attachment forms a force path that has at least one elastically deformable element,
wherein the damping rear engine attachment comprises at least one body, at least one connecting axis connecting the body, and one element of either the jet engine core or the primary structure, positioned in a longitudinal plane and a vertical plane, and at least one elastomer ring interposed between the body and the at least one connecting axis.

2. The propulsion assembly as claimed in claim 1, wherein the first and second ends of the damping rear engine attachment are positioned along a substantially vertical straight line.

3. The propulsion assembly as claimed in claim 1, wherein the body comprises a three-point shackle that comprises at least one plate having three through-orifices,
wherein the damping rear engine attachment comprises a first, a second, and a third connecting axes housed respectively in the first, second, and third through-orifices of the at least one plate and each connecting axes positioned in a vertical longitudinal plane,
the first connecting axis connecting the plate and the primary structure, and the second and third connecting axes connecting the plate and the jet engine core.

4. The propulsion assembly as claimed in claim 3, wherein the damping rear engine attachment comprises at least one elastomer ring interposed between each of the first, second, and third connecting axes and the body.

5. The propulsion assembly as claimed in claim 1, wherein the body comprises a base and first and second branches that form a V flared in a direction of the jet engine core and which, respectively, comprise first and second through-orifices,
wherein the damping rear engine attachment comprises a connection connecting the body and the primary structure and first and second connecting axes respectively housed in the first and second through-orifices of the body and each positioned in a longitudinal plane and a vertical plane, the first and second connecting axes connecting the body and the jet engine core.

6. The propulsion assembly as claimed in claim 5, wherein the first and second branches are configured to obtain a damping effect by stiffness.

7. The propulsion assembly as claimed in claim 5, wherein the damping rear engine attachment comprises at least one elastomer ring interposed between at least one of the first and second connecting axes and the body.

8. The propulsion assembly as claimed in claim 5, wherein the body comprises a contact face pressed against the primary structure and a cylindrical tenon of spigot projecting with respect to the contact face,
wherein the damping rear engine attachment comprises a housing, provided at the primary structure, configured to house with a tight fit the cylindrical tenon of the spigot and a holding system configured to hold the body pressed against the primary structure,
the cylindrical tenon of the spigot of the body and the housing of the primary structure reacting to shear forces positioned in an approximately horizontal plane, the holding system reacting to tensile forces oriented approximately vertically.

9. The propulsion assembly as claimed in claim 5, wherein the damping rear engine attachment comprises a waiting fail-safe backup safety connection connecting the body and the jet engine core and configured not to generate a force path when the first and second connecting axes are in an operative state and to generate a force path in an event of failure of at least one of the first and second connecting axes.

10. The propulsion assembly as claimed in claim 5, wherein the damping rear engine attachment comprises at least one elastomer ring interposed between each of the first and second connecting axes and the body.

11. The propulsion assembly as claimed in claim 1, wherein each elastomer ring is made from a material having a stiffness configured for a damping effect.

12. An aircraft comprising:
at least one propulsion assembly as claimed in claim 1.
